(19) United States
(12) Patent Application Publication
(10) Pub. No.: US 2020/0205442 A1
(43) Pub. Date: Jul. 2, 2020

(54) COMPREHENSIVE NUTRITION PET FOOD

(71) Applicant: Unicharm Corporation, Ehime (JP)

(72) Inventors: Junya Sakoda, Itami-shi (JP); Fumisato Yoshiga, Itami-shi (JP)

(73) Assignee: Unicharm Corporation, Ehime (JP)

(21) Appl. No.: 16/707,512

(22) Filed: Dec. 9, 2019

(30) Foreign Application Priority Data
Dec. 28, 2018 (JP) 2018-247012

(51) Int. Cl. A23K 20/116; A23K 10/16; A23K 10/30; A23K 50/40

(52) U.S. Cl. CPC A23K 20/116; A23K 50/40; A23K 10/30; A23K 10/16

(57) ABSTRACT

A comprehensive nutrition pet food that satisfies a nutritional food standard for a dog or a cat, the comprehensive nutrition pet including a unicellular organism ingredient containing astaxanthin and being free of meals, in which a content of the astaxanthin is 0.0012% to 0.0080% by mass, relative to a total amount of the comprehensive nutrition pet food, and an a* value of the comprehensive nutrition pet food in an L*a*b* color space is 8.0 to 20.

### BACKGROUND OF THE INVENTION

### Field of the Invention

The present invention relates to comprehensive nutrition pet food.

Priority is claimed on Japanese Patent Application No. 2018-247012, filed on Dec. 28, 2018, the content of which is incorporated herein by reference.

### Description of Related Art

Pet foods mainly targeting dogs and cats are roughly classified into dry foods with a water content of about 10%, soft foods with a water content of about 15% to 35%, and wet foods with a water content of about 80%.

Among them, the dry food has advantages such as preservation stability, simple feeding, and hard physical property that contributes to the health of teeth and jaws.

In general, in pet food, ingredients such as cereals, beans, starches, vegetable proteins, meat, seafood, vegetables, and additives (such as vitamins, minerals, amino acids, flavor ingredients, fibers, colorants, powdery palatability improvers) are mixed.

In recent years, natural-oriented and health-oriented users increases, and natural material ingredients are desired as ingredients for the pet food. Among them, a natural material colorant is particularly desired.

As the natural material colorant, tomato powder, astaxanthin, and the like are known.

Patent Literature 1 discloses a production-increasing agent for breeding mammals and production mammals, including at least one xanthophyll (preferably natural astaxanthin), and describes that production of breeding animals and production animals can be increased.

In addition, patent Literature 2 discloses a method for treating and improving diabetes and diabetic complications, including administering pet food containing astaxanthin and/or ester thereof to a pet, and describes that the method has an effect of deodorizing excrement such as feces and urine of pets, a sleep improvement effect, a sensitivity improvement effect, a visual improvement effect, and effects of treatment, improvement, and prevention of diabetes and diabetic complications.

### DOCUMENTS OF RELATED ART

### Patent Literature

[Patent Literature 1] Japanese Patent No. 3620858

[Patent Literature 2] Japanese Patent No. 4933097

### SUMMARY OF THE INVENTION

In the related art, synthetic colorants such as Red No. 40, Red No. 102, and Red No. 106 are generally used for coloring pet food. Pet food containing a synthetic colorant tends not to be preferred by a natural-oriented or health-oriented user.

On the other hand, a natural colorant (natural red colorant) was not intended to color a food granule itself of pet food as described above, but was used as ingredients of dietary supplements or therapeutic food for the purpose of increasing the production of breeding animals and production animals or treating and improving diabetes and diabetic complications. Therefore, the amount of the natural colorant was large, and a meat-like color that is generally required for pet food was not exhibited. In usual, dietary supplements and therapeutic food are used as supplements that are fed several times a month. Therefore, a user has little to worry about an appearance thereof.

Also, even in natural material ingredients, meals (such as chicken meal) had a problem of poor image of residue of edible meat. Therefore, even when an appropriate inspection was performed and there was no problem in quality, there was a user who did not want to mix the meals.

As an alternative ingredient (protein source) for meals, for example, it is known to use vegetable protein. However, many vegetable proteins are white. Therefore, when a colorant is added to pet food using vegetable protein instead of the meals, pet food tends to be dark and to have an artificial color.

Comprehensive nutritional food intended to be fed as a main meal for every day is pet food that is given to a pet by a user routinely. Therefore, the comprehensive nutritional food is required to contain a natural material as an ingredient, and do not contain an ingredient with strong negative image even in a case of the natural material ingredient, and exhibit a natural meat color.

The present invention has been made in view of the above circumstances, and an object thereof is to provide comprehensive nutrition pet food that includes, as an ingredient, a natural material generally accepted by a user, and has a meat-like color.

The present invention has the following aspects.

[1] Comprehensive nutrition pet food that satisfies a nutritional food standard for a dog or a cat, including:

a unicellular organism ingredient containing astaxanthin,

in which the comprehensive nutrition pet food is free of meals,

a content of the astaxanthin is 0.0012% to 0.0080% by mass, relative to a total amount of the comprehensive nutrition pet food, and

an a* value of the comprehensive nutrition pet food in an L*a*b* color space is 8.0 to 20.

[2] The comprehensive nutrition pet food according to [1],

in which the content of the astaxanthin is 0.0012% to 0.0056% by mass, relative to the total amount of the comprehensive nutrition pet food.

[3] The comprehensive nutrition pet food according to [1] or [2],

in which the unicellular organism ingredient is Haematococcus pluvialis or phaffia yeast.

[4] The comprehensive nutrition pet food according to any one of [1] to [3], further including:

wheat flour,

in which a content of the wheat flour is 35% to 70% by mass, relative to the total amount of the comprehensive nutrition pet food.

[5] The comprehensive nutrition pet food according to any one of [1] to [4], further including:

vegetable protein,

in which the vegetable protein is one or more selected from the group consisting of corn gluten meal, wheat protein, legume protein, rice protein, and potato protein.

[6] The comprehensive nutrition pet food according to [5],

in which the vegetable protein is the wheat protein or the legume protein.

[7] The comprehensive nutrition pet food according to [5] or [6],

in which a content of the vegetable protein is 0.5% to 30% by mass, relative to the total amount of the comprehensive nutrition pet food.

According to the present invention, comprehensive nutrition pet food that includes, as an ingredient, a natural material generally accepted by a user, and has a meat-like color is obtained.

### DETAILED DESCRIPTION OF THE INVENTION

In the present specification, the term “pets” indicates animals that have been bred by people. In a narrower sense, pets are animals being cared for by their owners. Further, the term “pet food” indicates feed for pets. The pet food of the present invention can be sold as “animal feed” or “animal food”.

“Comprehensive nutrition food” is intended to be fed to a dog or a cat as a main meal for every day, out of pet food, and is a nutritionally balanced product capable of maintaining health at a specified growth stage only by the pet food and water. As a standard of the comprehensive nutrition food, for example, a standard defined by Association of American Feed Control Officials (AAFCO) is used.

In the present specification, “comprehensive nutrition food” may be a food satisfying a standard of any stage of “puppy or kitten phase/growth phase”, “fully-grown dog or cat phase/maintenance phase”, and “pregnancy phase and lactation phase”, regardless of a growth stage, and may also be used for “all growth stages” or “all stages” that satisfy all three stages.

In the present specification, L*, a*, and b* are values represented by L*a*b* color space measurement (JIS Z 8729) standardized by International Commission on Illumination (CIE). In L*a*b*, the L* represents lightness of color as a diffused color in a black direction when the value is 0 and in a white direction when the value is 100. The a*b* represents chromaticity. The a* is a hue between red and green. A negative value represents a hue in a green direction and a positive value represents a hue in a red direction. The b* is a hue between yellow and blue, a negative value represents a hue in a blue direction, and a positive value represents a hue in a yellow direction. The L*a*b* is expressed as three-dimensional coordinates.

In the present specification, granular pet food means a collection of granules used as a part or all of pet food. In the present specification, granules not coated with a powdery palatability improver, oil and fat, or the like (non-coated granules) are also referred to as “food granules”.

In the present specification, “palatability” is an index of whether or not a pet likes to eat and is attributed to texture, taste, smell, and the like.

In the present specification, “coating” with a powder means that the powder is applied to a surface of a granule and adheres to the surface of the granule.

In the present specification, the “coating” with a liquid means that the liquid is applied to a surface of a granule and adheres to the surface of the granule, and also includes a case where some or all of the applied liquid soaks into the granule. For example, “coating” with oil and fat means that the oil and fat is applied to a surface of a granule and adheres to the granule, and also includes a case where some or all of the applied oil and fat soaks into the granule (impregnated therewith).

In the present specification, a value of a water content is a value obtained by an atmospheric pressure heating and drying method.

In the atmospheric pressure heating and drying method, an object to be measured is pulverized by a pulverizer so as to pass through a 1 mm sieve, and this is used as an analysis sample. 2 to 5 g of the analysis sample is accurately weighed and placed in an aluminum weighing pan. The analysis sample is dried for 2 hours at 135° C. and is allowed to be cooled in a desiccator. Then, a weight of the analysis sample is accurately weighed. The water content is determined from a weight difference of the analysis sample before and after drying.

More specifically, the object to be measured is pulverized by a pulverizer so as to pass through a 1 mm sieve, and this is used as an analysis sample. The mass (W1 gram) of an aluminum weighing can is measured in advance as a constant weight value. The analysis sample is put into the aluminum weighing can and the mass (W2 gram) is weighed. Next, the analysis sample is dried for 2 hours at 135° C. using a forced circulation hot air dryer. After allowing the analysis sample to be cooled in a dry atmosphere (in a silica gel desiccator), the mass (W3 gram) is weighed. The water content of the analysis sample is determined from the obtained each mass using the following equation.

Water content of analysis sample (unit: % by mass)=(W2−W3)/(W2−W1)×100

The water content is a value measured immediately after opening a final product within 30 days from the date of production or a value measured under the same conditions as this.

### Comprehensive Nutrition Pet Food

The comprehensive nutrition pet food according to the present embodiment satisfies a nutritional food standard for a dog or a cat, includes a unicellular organism ingredient containing astaxanthin, and is free of meals, in which a content of the astaxanthin is 0.0012% to 0.008% by mass, relative to a total amount of the comprehensive nutrition pet food, and an a* value of the comprehensive nutrition pet food in an L*a*b* color space is 8.0 to 20.

Since the comprehensive nutrition pet food according to the present embodiment is colored by a natural colorant, it is possible to give a good impression to a natural-oriented user. In addition, since the comprehensive nutrition pet food does not contain meals that have a strong negative image, and has a meat-like color, it does not give anxiety that the food may affect the health of a pet during feeding. Therefore, the comprehensive nutrition pet food according to the present embodiment is useful as a comprehensive nutrition pet food.

In the comprehensive nutrition pet food according to the present embodiment, the a* value in the L*a*b* color space is 8.0 to 20, preferably 8.0 to 18, more preferably 8.5 to 16, and still more preferably 8.8 to 14.

When the a* value in the L*a*b* color space is within the above range, the pet food will have a meat-like color.

In the comprehensive nutrition pet food according to the present embodiment, the b* value in the L*a*b* color space is preferably 10 to 30, more preferably 14 to 26, and still more preferably 18 to 22.

Further, the L* value in the L*a*b* color space is preferably 40 to 70, more preferably 45 to 65, and still more preferably 50 to 60.

When the L* value and the b* value in the L*a*b* color space are within the above ranges, the pet food will be likely to have a more meat-like color.

That is, in the comprehensive nutrition pet food according to the present embodiment, it is most preferable that the a* value in the L*a*b* color space is 9.0 to 14, the b* value is 18 to 22, and the L* value is 50 to 60.

When the a* value, the L* value, and the b* value in the L*a*b* color space are within the above ranges, the pet food will be likely to have the most meat-like color.

### Colorimetry Method

As a colorimetry method for the comprehensive nutrition pet food according to the present embodiment, for example, the comprehensive nutrition pet food is pulverized, the pulverized product is added to a 10 mL volume container for measurement in an amount of approximately 80%, and a colorimetric color difference meter is used, whereby it is possible to perform the colorimetry.

The comprehensive nutrition pet food according to the present embodiment may be any of dry food (water content of about 10%), soft food (water content of about 15% to 35%), wet food (water content of about 80%), semi-moist food (water content is between the soft food and the wet food), jerky, and the like. However, since there are advantages such as preservation stability, simple feeding, and hard physical property that contributes to the health of teeth and jaws, it is preferably dry food.

In the comprehensive nutrition pet food according to the present embodiment, the water content is preferably 3.0% to 14% by mass, more preferably 5.0 to 13% by mass, and still more preferably 8.0 to 12% by mass for comprehensive nutrition pet food for dogs. In a case of the comprehensive nutrition pet food for cats, the water content is preferably 2.0% to 10% by mass, more preferably 3.0 to 9.0% by mass, and still more preferably 4.0 to 8.0% by mass. When the water content is within the above range, sufficient palatability can be obtained.

The comprehensive nutrition pet food according to the present embodiment is preferably granular pet food, more preferably puffed granules. The puffed granule indicates a granule obtained by forming a mixture of the ingredients into a granular shape and also indicates a granule obtained by performing a puffing step of foaming inside the mixture of the ingredient. The puffing step indicates a step of generating a gas in the mixture of the ingredients using a technique of carrying out heating, fermentation, a chemical reaction, or pressure reduction. In the puffing step, as a gas is generated, the volume of the ingredient mixture is increased so as to have porous properties. Further, as the volume of the mixture of the ingredients is increased, the bulk density thereof is decreased. Before, after, or at the same time with the puffing step, the “puffed granule” is obtained by forming the mixture of the ingredients in a granular shape.

On the other hand, a non-puffed granule indicates a granule produced without performing the puffing step.

Hereinafter, each component contained in the comprehensive nutrition pet food according to the present embodiment will be described in detail.

### Unicellular Organism Ingredient Containing Astaxanthin

The comprehensive nutrition pet food according to the present embodiment includes a unicellular organism ingredient containing astaxanthin. Specific examples of the unicellular organism ingredient include algae such as Haematococcus pluvialis, yeasts such as phaffia yeast, marine bacteria, and brackish water-inhabiting bacteria. Among them, the Haematococcus pluvialis or the phaffia yeast is preferable, from the viewpoints of easy culturing or extraction, containing the astaxanthin at a high concentration, and high productivity.

Haematococcus pluvialis

The Haematococcus pluvialis is usually green algae. Therefore, it has a high chlorophyll content and is green. However, when stressed, an astaxanthin content increases and becomes a red sphere. In the comprehensive nutrition pet food according to the present embodiment, Haematococcus pluvialis containing a large amount of astaxanthin is used. In addition, examples of the green algae belonging to genus Haematococcus include Haematococcus pluvialis, Haematococcus lacustris, Haematococcus capensis, Haematococcus deroebakensis, and Haematococcus zimbabwiensis.

In the comprehensive nutrition pet food according to the present embodiment, the Haematococcus pluvialis may be Haematococcus pluvialis itself, may be in a raw and dried state, or may be an extract thereof. Examples of the extract of the Haematococcus pluvialis include those obtained by pulverizing cell walls and extracting with an organic solvent such as acetone, ether, chloroform, and alcohol, and those extracted with carbon dioxide in a supercritical state.

Among the above, the Haematococcus pluvialis in the comprehensive nutrition pet food according to the present embodiment is preferably an ingredient containing the extract of the Haematococcus pluvialis (Haematococcus pluvialis extract ingredient).

Examples of the Haematococcus pluvialis extract ingredient includes a liquid ingredient in which a Haematococcus pluvialis extract is dispersed in a solvent such as glycerin and propylene glycol, Haematococcus pluvialis extract, and a powder ingredient containing an excipient (such as sucrose, gelatin, and silicon dioxide). However, it is particularly preferable to use Haematococcus pluvialis extract ingredient, which is a powder ingredient, from the viewpoint of high appeal to a natural or health-oriented user.

Phaffia Yeast

The phaffia yeast is a spore-free yeast that inhabits the sap of dogwood and oak and forms pink to red colonies.

In a comprehensive nutrition pet food according to a first aspect of the present invention, the phaffia yeast may be phaffia yeast itself, may be in a raw and dried state, or may be a treated phaffia yeast. Examples of the treated phaffia yeast include those obtained by subjecting the cell wall of phaffia yeast to an enzyme treatment, a mechanical treatment, or an alkali treatment. Specific examples of the treated phaffia yeast include a liquid ingredient in which a treated product of phaffia yeast is dispersed in a solvent such as glycerin and propylene glycol, a treated product of phaffia yeast, and a powder ingredient containing an excipient (such as citric acid and calcium carbonate).

Among the above, the phaffia yeast in the comprehensive nutrition pet food according to the present embodiment is preferably phaffia yeast in a raw and dried state, from the viewpoint of high appeal to a natural or health-oriented user.

In the comprehensive nutrition pet food according to the present embodiment, a content of the astaxanthin is 0.0012% to 0.0080% by mass, preferably 0.0012% to 0.0072% by mass, more preferably 0.0012 to 0.0064% by mass, and still more preferably 0.0012 to 0.0056% by mass, relative to a total amount of the comprehensive nutrition pet food.

When the content of the astaxanthin is within the above range, it becomes easy to prepare the pet food in a meat-like color. Also, since the astaxanthin has anti-oxidant activity, when the content of the unicellular organism ingredient is within the above range, it is possible to prevent oxidation of ingredients of comprehensive nutrition pet food at a production stage and ingredients of the comprehensive nutrition pet food from deteriorating.

A content of the unicellular organism ingredient is preferably 0.3% to 2.0% by mass, more preferably 0.3% to 1.8% by mass, still more preferably 0.3% to 1.6% by mass, and particularly preferably 0.3% to 1.4% by mass, relative to a total amount of the comprehensive nutrition pet food.

Examples of a method of evaluating antioxidant power of the comprehensive nutrition pet food according to the present embodiment include a single oxygen absorption capacity (SOAC) measuring method.

In the SOAC method, a singlet oxygen generator and an indicator that decomposes by single oxygen (for example, Endoperoxide reagent) are added to a food extract liquid and reacted at 35° C. The amount of reduction in the amount of the indicator (absorbance) is measured over time. The higher the remaining amount of the indicator, the stronger the antioxidant activity of the comprehensive nutrition pet food.

The comprehensive nutrition pet food according to the present embodiment preferably further includes wheat flour and vegetable protein.

Wheat Flour

The wheat flour has a particularly high protein digestibility among cereals (such as corn, wheat, rice, barley, buckwheat, and rye), which is preferable. Furthermore, since the whiteness of wheat flour is high, it becomes easy to prepare the comprehensive nutrition pet food according to the present embodiment in a meat-like color.

A content of the wheat flour is preferably 35% to 70% by mass, more preferably 40% to 65% by mass, and still more preferably 45% to 60% by mass, relative to the total amount of the comprehensive nutrition pet food.

When the content of the wheat flour is within the above range, it becomes easy to tone the pet food in a meat-like color.

Vegetable Protein

The comprehensive nutrition pet food according to the present embodiment requires a protein source other than meals in order to satisfy the standard of the comprehensive nutritional food, but it may be difficult to mix so much wheat flour as the protein source, in some cases. In this case, the following animal protein or vegetable protein is preferably contained.

Examples of the animal protein include livestock or meat, such as Beef, pork, lamb, venison, and hare meat; meats such as chicken, turkey, quail, and poultry and fish such as tuna, Katsuobushi, and horse mackerel; crustaceans such as shrimp and crab; molluscs such as octopus and squid; shellfish such as scallops and scallops; fish extracts; and seafood such as bonito.

Examples of the vegetable protein include corn gluten meal, wheat protein, legume protein, rice protein, and potato protein.

Among the above, the comprehensive nutrition pet food according to the present embodiment preferably contains the vegetable protein. The vegetable protein is preferably one or more selected from the group consisting of wheat protein, legume protein, and potato protein, more preferably the wheat protein or the legume protein, and still more preferably the legume protein.

Specific examples of the legume protein include soy protein, pea protein, lentil protein, and chickpea protein. Since the legume protein has a high degree of whiteness, and it becomes easy to tone the pet food into a meat-like color, which is preferable.

A content of the vegetable protein is preferably 0.5% to 30% by mass, more preferably 1% to 25% by mass, and still more preferably 5% to 20% by mass, relative to the total amount of the comprehensive nutrition pet food.

The composition of the ingredients is not particularly limited. It is preferable to set the composition so as to satisfy the standard of the comprehensive nutritional food and to obtain good formability.

Examples of the composition of a dry type comprehensive nutritional pet food (including external additives) are as follows.

### Composition Example of Dry Type Comprehensive Nutrition Pet Food

The dry type comprehensive nutritional pet food contains 10% to 70% by mass of cereals, beans, and starch in total; 1% to 70% by mass of meat and seafood in total; 1% to 70% by mass of vegetable protein; 1% to 20% by mass of external additives; and the remaining other components.

A shape of the granule forming the granular pet food according to the present embodiment is not particularly limited as long as it is a shape suitable for a pet to eat.

For example, all shapes such as a spherical shape, an ellipsoid shape (meteorite shape), a donut shape, a pellet shape, a columnar shape, a polygonal column shape, a plate shape, a clover shape, a heart shape, a star shape, and a cross shape are applicable.

In addition, a size of the granule may be a small granule shape that allows a pet to cheek with a bite, or a large granule shape that allows a pet to bite over multiple times.

For example, regarding the size of the food granule, both the minor axis and the major axis are preferably 3 to 30 mm, more preferably 6 to 16.5 mm, and still more preferably 7 to 12 mm.

In the comprehensive nutrition pet food according to the present embodiment, ingredients known in pet food, other than the above-described ingredients can be appropriately used.

Specific examples of powder ingredient include cereals (such as corn, wheat, wheat bran, rice, bread crumbs, barley, buckwheat, and rye), potatoes (such as sweet potatoes and, potatoes), beans (such as whole soybeans), starches (such as wheat starch, corn starch, rice starch, potato starch, tapioca starch, sweet potato starch, sago starch, and modified starch), vegetables, seeds, mushrooms, fruits, algae, eggs, sugars, milk, and additives (such as vitamin, mineral, amino acid, a flavor ingredient, a fiber, a colorants, and a powdery palatability improver).

More specific examples of the powdery palatability improver include animal ingredient extracts, vegetable ingredient extracts, yeast extracts, and dried yeast products.

Specific examples of liquid ingredient (including semi-solid ingredient) include water, oil and fat (animal oil and fat such as chicken oil, lard, beef tallow, milk fat, and fish oil; and vegetable oil and fat such as olive oil, cacao oil, palm oil, palm kernel oil, coconut oil, coconut butter, and camellia oil), liquid sugar, a liquid palatability improver, a moisturizer, a preservative, an emulsifier, a flavor, and a colorant.

The colorant also includes synthetic colorants such as Red No. 40, Red No. 102, and Red No. 106, but the comprehensive nutrition pet food according to the present embodiment preferably does not contain the synthetic colorant.

### Method of Producing Comprehensive Nutrition Pet Food

As a method of producing the comprehensive nutrition pet food of the present embodiment, for example, the well-known method to be described later can be used.

### Granulating Step

A granulating step is a step of granulating a mixture of the ingredients to obtain a granule.

Examples of the granulating step include a method in which ingredients are mixed to form a mixture of the ingredients, and the mixture of the ingredients is formed to have a granule shape (granulated).

Specific examples of the granulating step include a method of producing a granule (puffed granule) using an extruder.

As a method of producing granules using an extruder, for example, a method described in “Small Animal Clinical Nutrition 5th Edition” (edited by Michael S. Hand, Craig D. Thatcher, Rebecca L. Remillard, Philip Roudebusg, and Bruce J. Novotny, published by Mark Morris Associates; 2014; p. 209 to 215) can be used.

An example of the method of producing granules using an extruder is as follows. First, ingredients of the granules are pulverized as necessary and mixed. The ingredients may be mixed while being pulverized using a grinder or the like. Further, water (which volatilizes during the producing step and is not finally included in the ingredient composition) is added thereto as necessary to obtain a mixture of the ingredients.

The obtained mixture of ingredients is put into the extruder, heated, pressed, and extruded from an outlet. The outlet is provided with a plate in which a hole having a predetermined shape is formed and a cutter cutting the mixture of ingredients extruded from the plate to have a predetermined length (thickness). At the same time with the extrusion of the mixture of ingredients from the hole in the plate and the formation of the mixture in a predetermined shape by cutting the mixture using a cutter, the mixture of ingredients are released to the atmospheric pressure from the pressurized state so that water vapor in the mixture of ingredients expands, and the mixture of ingredients is puffed, thereby obtaining porous granules.

### Drying Step

A drying step is a step of drying the granules obtained by the granulating step.

Examples of the method of drying the granules include known methods such as a method of drying naturally, a method of drying by blowing hot air, a method of drying under reduced pressure, and a method of drying by freeze drying. Among these drying methods, a method of drying by blowing hot air is preferable in terms of improving the flavor of the pet food.

A temperature of the granule at the time of drying and a temperature of the hot air blown on the granule are not particularly limited. For example, the temperature of the hot air is preferably 150° C. or lower. Further, a lower limit value of the temperature of the hot air is not particularly limited, is usually a temperature exceeding room temperature, and preferably 30° C. or higher. In a case where drying is performed at this temperature range, heat treatment time is preferably 1 minute to 120 minutes.

When the temperature and the time are equal to or more than the lower limit value of the above temperature range and the time range, the granules can be dried in a relatively short time. When the temperature and the time are equal to or less than the upper limit of the temperature range, granules are prevented from being heated too much.

### Oil and Fat Coating Step

The method of producing the comprehensive nutrition pet food of the present embodiment may further include an oil and fat coating step.

The oil and fat coating step is a step of coating the food granule obtained by the drying step, with oil and fat.

As a method of coating the food granule with oil and fat, for example, a method of spraying oil and fat on the food granule, a method of stirring the granule and oil and fat put in a container such as a tank with a stirrer, or a vacuum coating method can be used.

The vacuum coating method is a method of reducing the pressure in a state in which the heated granules and the oil and fat are in contact with each other or adhere to each other. When using the vacuum coating method, not only the surface of the food granule but also an inside of the food granule can be impregnated with oil and fat.

A degree of pressure reduction in the vacuum coating method is not particularly limited. The degree of pressure reduction may be adjusted suitably according to the size or hardness of the food granule. For example, as the degree of pressure reduction, an extent by which the pressure is reduced to 0.1 to 0.3 atmosphere may be used.

The oil and fat coating step may be performed in multiple steps. For example, a method of adding some oil and fat to the food granule obtained by the drying step, stirring or shaking and mixing, and then adding the remaining oil and fat again may be used. When performing the oil and fat coating step in multiple steps, it is possible to prevent fine powder from being generated from the dried particles (powdering).

A temperature at which the oil and fat is added is not particularly limited as long as the oil and fat does not solidify, but is preferably as low as possible from the viewpoint of preventing the oil and fat from oxidizing, for example, 40° C. to 80° C.

### Powder Coating Step

The method of producing the comprehensive nutrition pet food of the present embodiment may further include a powder coating step.

The powder coating step is a step of coating the food granule obtained by the drying step or the granule coated with oil and fat, with a powdery palatability improver.

Examples of the method of coating the granule with the powdery palatability improver include a method in which the granules and the powdery palatability improver are placed in a container such as a tank and stirred with a stirrer, and a method of vibrating the container.

A temperature of the granules when the powdery palatability improver adheres to the granules is preferably 35° C. to 75° C., more preferably 40° C. to 65° C., and still more preferably 45° C. to 55° C. In this case, the temperature of the powdery palatability improver is preferably 10° C. to 25° C. When the temperature of the granules is in the above range, a coating amount (powder coating amount) of the powdery palatability improver adhered to the granules is likely to increase.

### EXAMPLES

The present invention will be described in more detail with reference to the following example, but the present invention is not limited to these examples.

### Example 1

Ingredients forming the comprehensive nutrition pet food were mixed with the composition shown in Table 1. The obtained mixture of the ingredients was put into an extruder and heat-treated at 100° C. to 140° C. for 1 to 5 minutes while kneading to pregelatinize starch components, and extruded and granulated into a granular shape at an outlet of the extruder and puffed at the same time. The obtained granules were subjected to a drying treatment at 90° C. for 60 minutes using a dryer to obtain comprehensive nutrition pet food of Example 1.

### Examples 2 to 5 and Comparative Examples 1 to 4

Comprehensive nutrition pet food of each example shown in Tables 1 and 2 was produced using the same method as that of Example 1.

TABLE 1

| | Example | Comparative | Comparative | Comparative |
|---|---|---|---|---|
| | 1 | Example 1 | Example 2 | Example 3 |
| Legume protein | 11 | 11 | 11 | 11 |
| Animal protein | 15 | 15 | 15 | 15 |
| Wheat flour | 57.4 | 54.7 | 57.6 | 57.4 |
| Cellulose | 3.0 | 3.0 | 3.0 | 3.0 |
| Beet pulp | 2.0 | 2.0 | 2.0 | 2.0 |
| Phaffia yeast | 0.3 | 3.0 | — | — |
| (content of | | | | |
| astaxanthin is | | | | |
| approximately | | | | |
| 0.8%) | | | | |
| Astaxanthin | — | — | 0.1 | 0.3 |
| Vitamins and | 2.8 | 2.8 | 2.8 | 2.8 |
| minerals | | | | |
| Beef tallow | 8.5 | 8.5 | 8.5 | 8.5 |
| Total | 100 | 100 | 100 | 100 |
| (% by mass) | | | | |

TABLE 2

| | | | | | Compara- |
|---|---|---|---|---|---|
| | Exam- | Exam- | Exam- | Exam- | tive |
| | ple 2 | ple 3 | ple 4 | ple 5 | Example 4 |
| Vegetable protein | 11 | 11 | 11 | 1 | 11 |
| Animal protein | 15 | 15 | 15 | 12 | 15 |
| Corn | 22 | 17 | 12 | — | 57.4 |
| Wheat flour | 35.4 | 40.4 | 45.4 | 70.4 | — |
| Cellulose | 3.0 | 3.0 | 3.0 | 3.0 | 3.0 |
| Beet pulp | 2.0 | 2.0 | 2.0 | 2.0 | 2.0 |
| Phaffia yeast | 0.3 | 0.3 | 0.3 | 0.3 | 0.3 |
| (content of | | | | | |
| astaxanthin | | | | | |
| is approximately | | | | | |
| 0.8%) | | | | | |
| Vitamins and | 2.8 | 2.8 | 2.8 | 2.8 | 2.8 |
| minerals | | | | | |
| Beef tallow | 8.5 | 8.5 | 8.5 | 8.5 | 8.5 |
| Total | 100 | 100 | 100 | 100 | 100 |
| (% by mass) | | | | | |

### Colorimetry Method for Comprehensive Nutrition Pet Food

First, comprehensive nutrition pet food in each example was uniformly pulverized using a Millser manufactured by Iwatani Corporation to obtain a pulverized product of comprehensive nutrition pet food in each example. Next, the pulverized product was put into a 10 mL volume container for measurement in an amount of about 80%, and for each of three locations, colorimetry was performed for each coordinate value in a CIELAB color space, by using a colorimetric color difference meter (trade name: ZE6000, manufactured by Nippon Denshoku Industries Co., Ltd.) according to a manual attached to the device.

The results are listed in Tables 3 and 4.

### Sensory Evaluation of Appearance of Comprehensive Nutrition Pet Food

The comprehensive nutrition pet food of Example 1 was compared with the comprehensive nutrition pet food of Comparative Examples 1 to 3, and a questionnaire (17 monitors) was conducted as to “which pet food looks like a natural meat-like color”. In addition, comprehensive nutrition pet food of Example 2 was compared with the comprehensive nutrition pet food of Comparative Example 4, and a questionnaire (17 monitors) was conducted as to “which pet food looks like a natural meat-like color”.

For the total number of responses to the above questions, a proportion of respondents who responded that the comprehensive nutrition pet food in each of the examples looked more like “a meat-like color” than the comprehensive nutrition pet food in each of the comparative example was calculated in terms of percentage (unit: %). The results are listed in Tables 5 and 6.

### Evaluation of Antioxidant Power at Production Stage of Comprehensive Nutrition Pet Food

Comprehensive nutrition pet food having a composition in which the phaffia yeast was removed from the composition of the comprehensive nutrition pet food of Example 1, and wheat flour were in the same amount as the removed phaffia yeast was produced in the same manner as in the comprehensive nutrition pet food of Example 1. The obtained comprehensive nutrition pet food is referred to as Comparative Example 5.

The comprehensive nutrition pet food of Example 1 and the comprehensive nutrition pet food of Comparative Example 5 were respectively put into 500 g of non-barrier packaging materials, and oxidation over time thereof was confirmed with a constant temperature and high humidity apparatus (temperature 37%, humidity 75% RH).

Oxidation over time of the comprehensive nutrition pet food was evaluated by SOAC method shown below.

### Extraction of Fat-Soluble Component

First, 100 mg of the comprehensive nutrition pet food (hereinafter referred to as sample) of each of Example 1 and Comparative Example 5 was weighed out and placed in a brown centrifuge tube (10 ml capacity). 2 to 3 ml of an extraction solvent (ethanol:chloroformheavy water=50:50:1) was added thereto and stirred (Operation 1). After allowing the brown centrifuge tube to stand, an extract was transferred to a brown volumetric flask (10 nil capacity) by using a pipette (Operation 2).

Operations 1 and 2 were repeated until the extract became colorless (until the sample turned white). Subsequently, after adjusting the amount of the resultant to 10 ml with an extraction solvent, the extract was filtered with a PTFE syringe filter (25 mm, 0.45 μm) to obtain a sample extract.

### Measurement by SOAC Method

0.5 ml of a mixed solution (DPBF: 94.4 mg/L) of diphenylbenzofuran (DPBF) and the extraction solvent and a mixed solution (D-α-Tocopherol: 0.5 mM) of D-α-tocopherol and the extraction solvent or 1 ml of the sample extract were put into a quartz cell with a stopper.

The extraction solvent was put into a blank and set in an ultraviolet-visible spectrophotometer (trade name: UV-1800, manufactured by Shimadzu Corporation), and 1.5 ml of a mixed solution (3-(1,4-epidioxy-4-methyl-1,4-dihydro-1-naphthyl)propionic acid: 316.5 mg/L) (Endoperoxide (EP) reagent) of 3-(1,4-epidioxy-4-methyl-1,4-dihydro-1-naphthyl)propionic acid and the extraction solvent was added to the quartz cell and the cell was set to a 6-cell holder. In a case of measuring the sample extract, a blank was set in a first cell, a mixed solution of the D-α-tocopherol and the extraction solvent was set in a second cell, and the sample extract as set in the third to sixth cells.

Next, each cell was set in an ultraviolet-visible spectrophotometer (trade name: UV-1800, manufactured by Shimadzu Corporation) set at a temperature of 35° C., and measurement of absorbance at 413 nm was started, and change in the absorbance over time for 2 hours was measured.

Since the absorbance changes depending on the color of the sample extract, the calculation was performed by subtracting the absorbance of only the sample.

The results are listed in Table 7.

TABLE 3

| | Example | Comparative |
|---|---|---|
| | 1 | Example 1 |
| L* | 53.1 | 50.9 |
| a* | 11.1 | 22.1 |
| b* | 21.2 | 19.7 |

TABLE 4

| | Example | Example | Example |
|---|---|---|---|
| | 2 | 4 | 5 |
| L* | 56.0 | 55.1 | 57.7 |
| a* | 8.8 | 10.5 | 9.9 |
| b* | 21.5 | 21.1 | 20.9 |

TABLE 5

| Invention | Comparative | Selected |
|---|---|---|
| product | product | proportion |
| Example 1 | Comparative | 100% |
| | Example 1 | |
| Example 1 | Comparative | 100% |
| | Example 2 | |
| Example 1 | Comparative | 100% |
| | Example 3 | |

TABLE 6

| Invention | Comparative | Selected |
|---|---|---|
| product | product | proportion |
| Example 2 | Comparative | 100% |
| | Example 4 | |

TABLE 7

| | | | 0 weeks | 3 weeks | 6 weeks |
|---|---|---|---|---|---|
| Measured | Acid value | Comparative | 8.32 | 9.14 | 9.23 |
| value | | Example 5 | | | |
| | | Example 1 | 6.70 | 7.12 | 7.07 |
| | Peroxide value | Comparative | 1.30 | 1.20 | 2.00 |
| | (meq/kg) | Example 5 | | | |
| | | Example 1 | ≤1.00 | ≤1.00 | ≤1.00 |
| | Carbonyl value | Comparative | 3.80 | 3.70 | 3.70 |
| | | Example 5 | | | |
| | | Example 1 | 3.20 | 3.20 | 3.10 |
| | TBA value | Comparative | 13.0 | 12.0 | 14.0 |
| | (nmol/g) | Example 5 | | | |
| | | Example 1 | 12.0 | 8.0 | 12.0 |
| | Iodine value | Comparative | 65.3 | 65.5 | 65.1 |
| | | Example 5 | | | |
| | | Example 1 | 61.9 | 62.4 | 63.1 |
| Rate of | Acid value | Comparative | | 10% | 1.0% |
| change | | Example 5 | | | |
| | | Example 1 | | 6% | −1.0% |
| | Peroxide value | Comparative | | −8.0% | 67% |
| | (meq/kg) | Example 5 | | | |
| | | Example 1 | | — | — |
| | Carbonyl value | Comparative | | −3.0% | 0% |
| | | Example 5 | | | |
| | | Example 1 | | 0% | −3.0% |
| | TBA value | Comparative | | −8.0% | 17% |
| | (nmol/g) | Example 5 | | | |
| | | Example 1 | | −33% | 50% |
| | Iodine value | Comparative | | 0% | −1.0% |
| | | Example 5 | | | |
| | | Example 1 | | 10% | 1.0% |

As shown in Tables 3 and 5, the comprehensive nutrition pet food of Example 1 has a moderate content of the phaffia yeast and the a* value of 8.0 to 20. Therefore, the comprehensive nutrition pet food of Example 1 was highly evaluated as compared to the comprehensive nutrition pet food of Comparative Examples 1 to 3, in terms of an evaluation of which pet food looks like a natural meat-like color.

In the comprehensive nutrition pet food of Comparative Example 4, since not the wheat flour with high whiteness but corn with strong yellowness was blended in a large amount, redness of the pet food was relatively weak and the a* value was less than 8.0.

Therefore, as shown in Tables 4 and 6, the comprehensive nutrition pet food of Example 2 having the a* value of 8.0 to 20 was highly evaluated as compared to the comprehensive nutrition pet food of Comparative Examples 4, in terms of an evaluation of which pet food looks like a natural meat-like color.

As shown in Table 7, it can be confirmed that the comprehensive nutrition pet food of Example 1 has a smaller change ratio of acid value than that of the comprehensive nutrition pet food of Comparative Example 5. Therefore, it can be confirmed that the deterioration degree of oil and fat contained in comprehensive nutrition pet food is small, and the comprehensive nutrition pet food of Example 1 has higher stability over time than that of the comprehensive nutrition pet food of Comparative Example 5.

From the above, it can be confirmed that the comprehensive nutrition pet food of the example contains a natural colorant and is free of meals, but has a meat-like color and appeals highly to natural-oriented and health-oriented users.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. Comprehensive nutrition pet food that satisfies a nutritional food standard for a dog or a cat, comprising:
a unicellular organism ingredient containing astaxanthin,
wherein the comprehensive nutrition pet food is free of meals,
a content of the astaxanthin is 0.0012% to 0.0080% by mass, relative to a total amount of the comprehensive nutrition pet food, and
an a* value of the comprehensive nutrition pet food in an L*a*b* color space is 8.0 to 20.

2. The comprehensive nutrition pet food according to claim 1,
wherein the content of the astaxanthin is 0.0012% to 0.0056% by mass, relative to the total amount of the comprehensive nutrition pet food.

3. The comprehensive nutrition pet food according to claim 1,
wherein the unicellular organism ingredient is Haematococcus pluvialis or phaffia yeast.

4. The comprehensive nutrition pet food according to claim 1, further comprising:
wheat flour,
wherein a content of the wheat flour is 35% to 70% by mass, relative to the total amount of the comprehensive nutrition pet food.

5. The comprehensive nutrition pet food according to claim 1, further comprising:
vegetable protein,
wherein the vegetable protein is at least one member selected from the group consisting of corn gluten meal, wheat protein, legume protein, rice protein, and potato protein.

6. The comprehensive nutrition pet food according to claim 5,
wherein the vegetable protein is the wheat protein or the legume protein.

7. The comprehensive nutrition pet food according to claim 5,
wherein a content of the vegetable protein is 0.5% to 30% by mass, relative to the total amount of the comprehensive nutrition pet food.
